(19) United States
(12) Patent Application Publication
(10) Pub. No.: US 2007/0036699 A1
(43) Pub. Date: Feb. 15, 2007

(54) Method of extracting contaminants from solid matter

(76) Inventor: Kazem Eradat Oskoui, Maple Grove, MN (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/581,880

(22) Filed: Oct. 17, 2006

Related U.S. Application Data
(63) Continuation of application No. 10/313,274, filed on Dec. 6, 2002.
(60) Provisional application No. 60/339,867, filed on Dec. 6, 2001.

(51) Int. Cl. A62D 3/00

(52) U.S. Cl. 423/27; 423/53; 423/87; 588/313

(57) ABSTRACT

An environmentally benign process for remediating contaminated matter includes contact with a lixiviant. The lixiviant contains a chelating agent which chemically reacts with a selected contaminant, forming a chelate soluble within the lixiviant and thus extracting the selected contaminant from the matter. The lixiviant, including the chelate, is separated from the particulate matter, and chemically treated to demobilize the chelate. The selected contaminant is separated from the lixiviant and sent for disposal or further processing. The remidiated matter is also sent for disposal or further processing.

### CROSS-REFERENCE TO RELATED APPLICATION(S)

This application claims the benefit of U.S. Provisional Patent Application No. 60/339,867 filed on Dec. 6, 2001.

### BACKGROUND OF THE INVENTION

Wood is an organic medium extremely suitable as a source of energy for bacteria, fungi, insects and some parasitic plants. Specifically, in the presence of moisture, wood becomes a suitable growing substrate for a diverse group of biota, resulting in continuous loss of wood density and strength. Over time, decay and destruction of the wood as a structural support is imminent. To retard or stop the decay, several biocides are used to enhance durability of the wood products. Such biocides include both organic and mineral compounds produced either synthetically or derived from natural products. Examples of such biocides include Chromated Copper Arsenate (CCA), Phenylcyclpiperidine (PCP) and Creosote. There are other wood preservatives in the market which are less hazardous or are not used as commonly as these three products. Since PCP and Creosotes are somewhat biodegradable and are also relatively less hazardous, remediation of CCA contaminated wood and other wastes is of primary concern. CCA wood preservatives include compounds such as copper sulfate (CuSO₄*5H₂O), sodium dichromate (Na₂Cr₂O₇*2H₂O) and arsenic pentoxide (As₂O₅*2H₂O).

As a result of high consumer acceptance of treated wood products for decks, fences and other residential applications, use of CCA wood preservative during the past three decades rapidly expanded. It is therefore expected that in the next two decades, the amount of CCA treated wood that will be removed from service will be approximately 12 million m³ per year in the USA and Canada. CCA contains substantial quantities of three elements of Arsenic (As), Copper (Cu), and Chromium (Cr) which are known carcinogens and biotoxins in minute quantities. One example indicated levels of 0.3% As, 0.32% Cr and 0.20% Cu concentrations in the CCA treated wood. These compounds can be released into the environment by several methods and processes. Some of the most important ways by which CCA compounds can be released into the environment are burning, mechanical abrasion, direct contact and acid release.

Burning: Burning CCA treated wood releases the chemical bond holding CCA compounds within the wood, and just one tablespoon of ash from CCA treated wood contains a lethal dose of Arsenic and other elements.

Mechanical abrasion: CCA treated wood particles are released when the wood is sawed, sanded or shaped. So far, no studies have been done on the health effects of exposure to CCA contaminated sawdust, but warning cards stapled to each bundle of CCA treated wood warns about avoiding sawdust.

Direct contact: In a study conducted by the Connecticut Agricultural Experiment Station, the authors found that Arsenic is released to the hand of a child by direct contact with Arsenic-treated wood. The amount ingested per day was estimated to be about 7 micrograms. This should be compared against an estimated 5 micrograms estimated in food and 5 to 100 micrograms (parts per billion) in drinking water.

Acid release: The same Connecticut Agricultural Experiment Station study found an average Arsenic concentration of 76 parts per million (ppm) under old CCA treated decks. The range was from 3 to 350 ppm, and the Connecticut State limit is 10 ppm of Arsenic in soil. It is suspected that acid rain and acidic deck-washes can hasten release of Arsenic from the wood.

Currently, American and Canadian environmental regulations allow the disposal of CCA treated lumber in landfills, and most of the out-of-service or Aspent@ treated wood ends up in landfills. In the future, treated wood will use increasingly more volumes of landfill space.

In addition to leaching and environmental impacts, there are considerable human and animal health implications associated with the use of CCA treated wood. According to a document published by Origen Biomedical of 2525 Hartford Road, Austin, Tex., USA 78703, a single 12″×2″×6″ treated timber contains about 27 grams of Arsenic; enough Arsenic to kill 250 adults.

In addition to the environmental and health implications, the cost of disposal of CCA contaminated wood is also an issue. The cost of disposal of the CCA contaminated wood varies greatly with the municipality responsible for the site and the type of site, for example lined vs unlined. However, the disposal of CCA treated wood is becoming an increasing concern with regulators and alternative disposal options are being examined.

As a result of a survey conducted in October of 2001, it was established that the cost of disposing CCA contaminated wood varied from $63/ton in South Dakota to about $148/ton in Maryland. In some largely populated municipalities, land filling of CCA contaminated wood is strongly discouraged.

In addition to the waste wood, substantial increase has also occurred in the production plant wastes that are listed as hazardous wastes. Assuming that each of the approximately 450 plants in treating wood with CCA in the USA and Canada dispose 6 drums of plant waste each year, with each drum weighing about 300 kg each per year, then about 1000 tons of CCA contaminated plant waste is generated per year in the USA and Canada. Wastes from treating plants consist of used filters, solution tank sludge, sump sludge, dirt, sawdust and plant sweepings. This material is collected, dried and disposed of by hazardous waste companies at a higher cost because of the extra controls required on transportation and containment security of the disposal site. Typical cost for disposal of this material is $ 300/drum. These costs are for year 2001 and are likely to increase rapidly once landfill space becomes more scarce and environmental laws more stringent.

Currently, a number of alternative approaches are being used for disposal of CCA contaminated wood and waste material. Some of these methods include burning/incineration, reuse in wood processing industry, biological detoxification and chemical extraction.

Burning/incineration of spent CCA treated wood in incinerators and kilns is not desirable due to release of toxins both in the off-gasses and in the ash. As discussed earlier, just one tablespoon of ash from a CCA treated wood fire contains a lethal dose of Arsenic. Some of the problems associated with disposal of CCA contaminated wood by burning are:
Detection: Arsenic gives no warning; it does not have a specific taste or odor.
Toxicity: There are no disputes that the ash from burning CCA wood is highly toxic.
Regulation: It is illegal to burn CCA treated wood in all 50 states.
Hazardous: Burning of CCA treated wood has serious implications for firefighters, cleanup and landfill operations.

Reuse of spent CCA treated wood to make composites such as wood-cement, OSB boards, etc., has not been widely accepted due to problems with other contaminations such as nails, paint, etc. Also, the undesirability of the finished product has discouraged the industry from utilizing CCA contaminated wood as a raw material for their products.

Biological detoxification, including the use of biological or biotechnological methods to detoxify spent treated wood, has also attracted some attention. However, due to the very nature of CCA, such as its biotoxicity, biological detoxification has not been very successful. Industry is reluctant to bio-engineer an arsenic resistant biota due to its adverse environmental and health implications. Chemical extraction of CCA from spent treated wood has attracted considerable attention, especially the use of acids to extract CCA from contaminated wood. However, a typical acid extraction requires 1.3 mole of acid per 1 mole of each of the elements (Cu, As and Cr) in the CCA solution along with other cations, including Na, K and Ca. This proves to be very expensive and uneconomical for large quantities of waste wood. Additionally, most of the acids are corrosive, thus require expensive corrosion resistant handling and treatment facilities. An environmentally sound and cost effective recycling method for CCA treated wood and other wastes will help alleviate the landfill and potential Chromium and Arsenic contamination problems.

### BRIEF SUMMARY OF THE INVENTION

The present invention includes an environmentally benign remediation system and process to extract contaminants from contaminated solid matter. The remediation system of the present invention comprises a lixiviant delivery system, a leaching reactor, a settling tank, a leachate processing system and a solids processing system. The process of the present invention includes the lixiviant delivery system applying a controlled amount of lixiviant to the contaminated solid matter contained within the leaching reactor. The lixiviant is leached through the contaminated solid matter to yield contaminant containing leachate and leached solid matter. The contaminate leachate includes dissolved contaminants from the contaminated solid matter. The leached solids are allowed to settle within the settling tank, and the contaminant containing leachate is removed as a supernatant and transferred to the leachate processing system. The leachate processing system demobilizes and extracts the contaminants from the leachate solution. The demobilized contaminants, along with other particulate matter separated from the contaminant containing leachate, are appropriately disposed. The remaining liquid is chemically augmented and recycled as lixiviant back into the lixiviant delivery system to be used for leaching contaminated solid matter. The leached solids are sent to the solids processing system where excess contaminate leachate is removed and sent to the leachate processing system. The dried solids, free of contaminants, are sent for disposal or further processing.

### BRIEF DESCRIPTION OF THE DRAWINGS

FIG. 1 is a block diagram illustrating a remediation system of the present invention.

### DETAILED DESCRIPTION

The present invention provides a remediation system and method for removing contaminants including, but not limited to, arsenic, chromium, copper and mercury. The present invention further provides an extraction and remediation method for removing radio active elements from contaminated solid matter including, but not limited to, uranium, cesium and plutonium. Non-exhaustive examples of solid matter include, but are not limited to, treated wood, soil, debris and sludge. The removal of the contaminants, preferably ex-situ, may occur directly from the whole solids or after communition such as chipping, grinding or shredding.

The remediation system and method of the present invention utilizes chemical processes to extract the contaminants. The chemical processes occur by applying a lixiviant to the contaminated solid matter to leach, dislodge and mobilize the contaminants into a contaminant containing leachate, thereby making them available for physical or biological extraction. By lixiviant is meant an aqueous solution to extract a soluble constituent from a solid mixture. The lixiviant comprises a variety of chelating agents that combine with metals and metalloids to form complex compounds, or chelates. Other terms used to describe chelating agents that form complex compounds include sequestering agents, complexing agents, ligands and coordination agents.

Upon forming the complex compounds, the dissolved contaminants are then either extracted from the contaminant containing leachate using extracting agents such as precipitants, cation sieves, organic extractants such as hexane and evaporators, or concentrated into a more condensed form for re-use or recycling. Once extracted, the contaminants may be properly disposed, and the remaining leachate solution may be treated to transform it into recycled lixiviant, which is returned back into the system for further contaminant remediation.

The use of acids and some salts in extracting metals from particulate matter is known. Typically, such chemicals form only one bond to a molecule of metal, while chelating agents form four or more bonds with the molecule of metal, thus increasing the efficiency of removal by several folds and the stability of the formed compounds. Chelating agents are substances whose molecules form several bonds to a single metal ion, or a multidentate liquid that forms a compound with the metal having a ring structure. Such resulting molecules are commonly referred to as chelates. An example of such a simple chelating agent is ethylenediamine. Compounds having a ring structure are inherently more stable, and are thus more difficult to remove from solution. Any free metal ion in solution, denoted by M⁺⁺, has water molecules coordinated in this kind of manner: M(H₂O)x++.

A ligand replaces these water molecules with another compound that forms a more stable structure, thus preventing the metal ion from reacting with the OH⁻ ion present in the precipitant at high pH levels. Since the metal ion is bound tightly by the ligand, the metal ion cannot form insoluble metal hydroxides M(OH)₂, which precipitate the metals out of solution.

An example of a chelating agent for use in the present invention includes ethylenediamine. A single molecule of ethylenediamine can form two bonds to a transition-metal ion such as nickel(II), Ni²⁺. The bonds form between the metal ion and the nitrogen atoms of ethylenediamine. The Ni²⁺ ion can form six such bonds, so a maximum of three ethylenediamine molecules can be attached to one Ni²⁺ ion. In some structures, the bonding capacity of the Ni²⁺ ion is completed by water molecules. Each water molecule forms only one bond to Ni²⁺, so water is not a suitable chelating agent. Because the chelating agent is attached to the metal ion by several bonds, chelating agents tend to be more stable than complexes formed with monodentate ligands such as water.

Another example of a chelating agent for use in the present invention is porphine. Porphine is similar to ethylenediamine in that it forms bonds to a metal ion through nitrogen atoms. Each of the four nitrogen atoms in the center of the molecule can form a bond to a metal ion. Porphine is the simplest of a group of chelating agents called porphyrins. Porphyrins have a structure derived from porphine by replacing some of the hydrogen atoms around the outside with other groups of atoms. An important porphyrin chelating agent is heme, the central component of hemoglobin, which carries oxygen through the blood from the lungs to the tissues. Heme contains a porphyrin chelating agent bonded to an iron(II) ion. Iron, like nickel, can form six bonds. Four of these bonds tie it to the porphyrin. One of two remaining bonds in iron holds an oxygen molecule as it is transported through the blood. Chlorophyll is another porphyrin chelating agent. In chlorophyll, the metal at the center of the chelating agent is a magnesium ion.

Another biologically significant chelating agent for use in the present invention is vitamin B-12. Vitamin B-12 is the only vitamin that contains a cobalt(II) ion, a metal, bonded to a porphyrin-like chelating agent. As far as is known, Vitamin B-12 is required in the diet of all higher animals. Vitamin B-12 is not synthesized by either higher plants or animals, but only by certain bacteria and molds.

A preferred chelating agent for use in the present invention, and of particular economic significance, is ethylenediaminetetraacetic acid (EDTA). EDTA can form four or six bonds with a metal ion, and also forms chelates with both transition-metal ions and main-group ions. EDTA is frequently used in soaps and detergents because it forms complexes with calcium and magnesium ions. These ions are in hard water and interfere with the cleaning action of soaps and detergents. EDTA binds to the calcium and magnesium ions sequestering and preventing their interference. In the calcium complex, [Ca(EDTA)]²⁻, EDTA is a tetradentate ligand, and chelation involves the two nitrogen atoms and two oxygen atoms in separate carboxyl groups. EDTA is also used extensively as a stabilizing agent in the food industry. In other applications, EDTA dissolves the calcium carbonate deposited from hard water without the use of corrosive acid. EDTA is also used in the separation of the rare earth elements from each other. The rare earth elements have very similar chemical properties, but the stability of the EDTA complexes formed varies slightly therewith. This slight variation allows EDTA to effectively separate rare-earth ions.

There are over 100 different salts of EDTA available in the market which can be used in relation to the present invention. A general formula of such salts includes, but is not limited to, the following: C₁₀H₁₂XNₙYₘO₈*4H₂O where X and Y are different metal cations and m and n are between 1 and 9. One such example is Ba(II)-EDTA (C₁₀H₁₂BaN₂Na₂O₈*4H₂O), where X is Ba(II), Y is Na (I) and m and n are both 2.

Dimercaprol, [2,3-dimercapto-1-propanol], is an effective chelating agent for heavy metals such as arsenic, mercury, antimony and gold. These heavy metals form particularly strong bonds to the sulfur atoms in dimercaprol. Dimercaprol was originally employed to treat the toxic effects of an arsenic-containing mustard gas called Lewisite, [dichloro(2-chlorovinyl)arsine], which was used in World War I.

Other commonly known chelating agents include EDDHA, (C₈H₂₀O₆N₂) [ethylenediaminedi(o-hydroxyphenylacetic) acid] and EHPG [N,N′-ethylenebis-2-(o-hydroxyphenyl) glycine]. Because of the strong bonds between phenolic groups and Fe(III), chelates of this type are much stronger than purely carboxylic chelating agents such as EDTA. The phenol-Fe(III) bond gives a red to purple color to the ferrated chelate. Furthermore, an additional chelating agent which can be effectively used in the process of the present invention is Diethylenetriaminepentacetic Acid (DPTA) and its variations such as DPTA-OH, (C₁₁H₁₈N₂O₉) [1,3-Diamino-2-hydroxypropane-N,N,N′,N′-tetraacetic acid]. For additional information regarding demobilization, reference may be made to Pribil, R. and V. Vesely, 1967, Determination of rare earths in the presence of phosphate; Chemist-Analyst, 56, 23, and Norvell, W. A., 1984, Comparison of chelating agents as extractants for metals in diverse soil materials, Soil Sci. Soc., Am. J., 48, 1285, which are herein incorporated by reference.

As discussed, leachate treatment is performed through chemical, physical and biological processes. The chemical process includes various chemicals which can be broken down into various categories: precipitants, replacement agents and reducing agents. Precipitants, such as thiocarbamates and sulfide, form an insoluble compound that is more stable than the chelate-metal compound, thus effectively “stealing” the metal away from the chelate, and dropping it out of solution. Precipitants can be highly effective, but it is important to realize that just because the metal has been removed does not mean that the ligand is in any way inactivated. Thus, if the treated waste solution is later mixed with solution bearing a metal ion, the solution will bond to and hold the newly introduced metal ion just as tightly as it did the old, and carry it through waste treatment just as easily.

Replacement agents such as ferrous sulfate are chosen dependent upon the fact that ligands have a preference for ferrous metals. For instance, given the choice of either copper or ferrous ions, EDTA will preferentially react with the ferrous ions. In other words, if enough ferrous ions are present, the EDTA (and certain other ligands) will be tied up, freeing the copper ions to react with the precipitator, and fall out of the solution as copper hydroxide. The key to making this work is to make sure that the replacement agent being used is preferred by all the ligands present over all the heavy metals that need to be removed.

Reducing agents such as sodium borohydride work by converting the heavy metals from the water soluble ion form back to the metal, which then precipitates out of solution. This approach is also effective, but again does not disable the ligand, thus leaving the ligand free to pick up metals at some point down stream, and carry the metals through waste treatment.

The preferred physical process of contaminated leachate treatment includes separation of target compounds from the leachate solution by means of physical filters, including reverse osmosis membranes, nano-filters or cation exchange resins. Centrifuge or other gravitational separation systems are also within the scope of the present invention. Alternatively, other physical separation methods may include activated carbon, zeolites or other absorption media.

The biological or biochemical processes of the contaminated leachate treatment include using anaerobic bacteria to reduce the soluble forms of the contaminants to metal form or using aerobic bacteria to oxidize the contaminants to insoluble metal oxides to gravitationally separate the oxides. Pseudomonas and nitrobactors are two examples of the bacteria used.

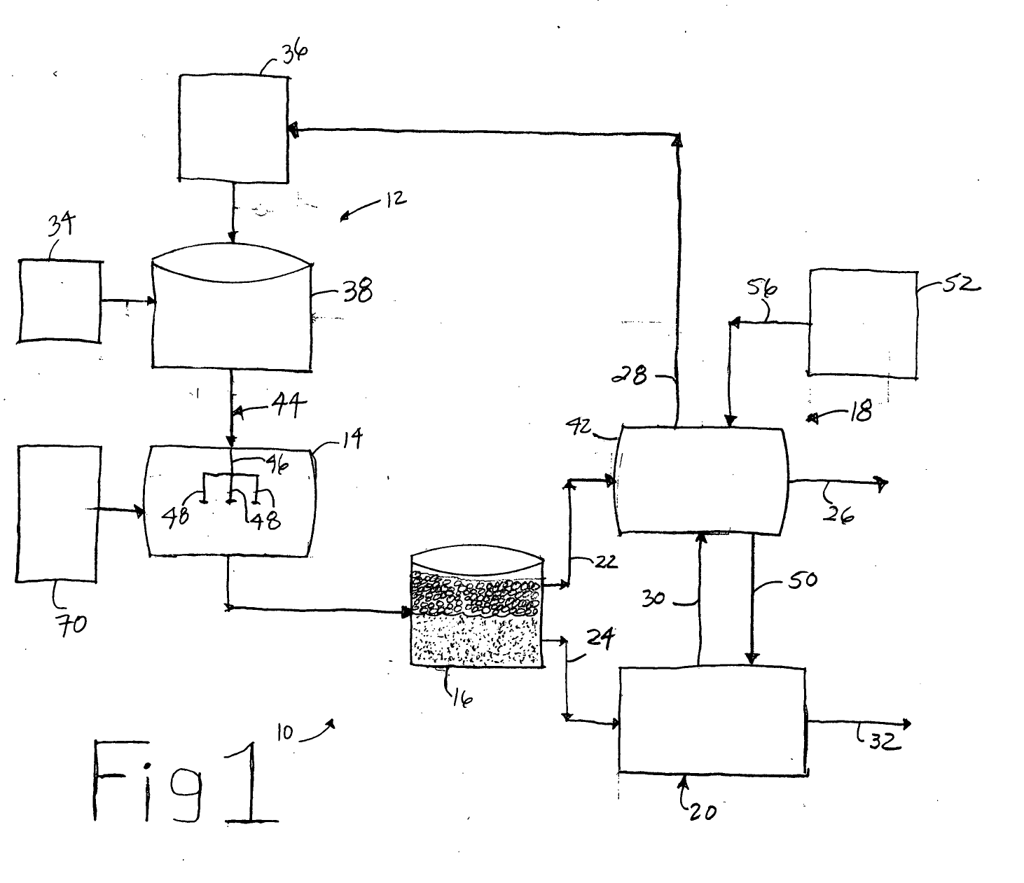

A preferred remediation system of the present invention is generally indicated at 10 in FIG. 1. The preferred remediation system 10 of the present invention comprises a lixiviant delivery system 12, a leaching reactor 14, a settling tank 16, a leachate processing system 18 and a solids processing system 20. The lixiviant delivery system 12 applies a controlled amount of lixiviant to the contaminated solid matter contained within the leaching reactor 14. The lixiviant is leached through the contaminated solid matter to yield contaminant containing leachate 22 and leached solid matter 24. The contaminate leachate 22 includes dissolved contaminants from the contaminated solid matter. The leached solids 24 are allowed to settle within the settling tank 16, and the contaminant containing leachate 22 is removed as a supernatant and transferred to the leachate processing system 18. The leachate processing system 18 demobilizes and extracts the contaminants from the leachate solution. The demobilized contaminants 26, along with other particulate matter separated from the contaminant containing leachate, are appropriately disposed. The remaining liquid is chemically augmented and recycled as lixiviant 28, which is fed back into the lixiviant delivery system 12 where it is again used for leaching contaminated solid matter. The leached solids 24 are sent to the solids processing system 20 where excess contaminant containing leachate 30 is removed and sent to the leachate processing system 18. The dried solids 32, free of contaminants, are sent for disposal or further processing.

The lixiviant delivery system 12 includes a water feed tank 34, a lixiviant tank 36, a mixing tank 38 and a dispensing system 44. The water feed tank 34 is in fluid connection with the mixing tank 38 to provide water. The lixiviant tank 36 is in fluid connection with the mixing tank 38 to provide recycled lixiviant 28 from the lixiviant recycling line 28. The mixing tank 38 is in fluid connection with the leaching reactor 14 to provide the reactor 14 with a controlled amount of lixiviant. The mixing tank 38 is preferably constructed of a suitable material, such as stainless steel, to withstand corrosion caused by the lixiviant.

The dispensing system 44 may vary according to the type of contaminated solid matter, type of reactor, or the state of the solid matter, whether the solid matter be chipped, ground or whole. Preferably, the dispensing system 44 includes a lixiviant delivery line 46 connected to a single or plurality of applicators 48. Each applicator 48 conveys the lixiviant to the contaminated solid matter contained within the reactor 14. Each applicator 48 may be a point applicator or a non-point applicator such as a sprinkler-type applicator. The point applicator may be a perforated pipe or a combination of distributed perforated pipes that are designed for suspension over the contaminated solid matter. The non-point applicators may be implemented with conventional sprinklers that have adequate orifices for dispensing the lixiviant, as well as recycled lixiviant, which may contain some impurities.

The reactor 14 interconnects between the lixiviant delivery system and the settling tank 16. The reactor 14 is designed to contain the contaminated solid matter and the lixiviant in order to maintain environmental integrity and create a contaminant containing leachate basin reaction process. The reactor 14 may be constructed from any durable construction material such as concrete, glass coated steel, stainless steel, HDPE, fiber glass or similar materials. The reactor 14 is constructed to sustain fluid pressure, endure pH fluctuations and resist high temperatures. To avoid excessive heat loss during the reaction process, the reactor 14 may be insulated and covered with suitable material. The reactor 14 may further include a pressure transducer (level sensor), fluid supply lines, heat exchangers, heat sensors, a mixing device, a pH meter and a dissolved oxygen meter, all of which are known to those skilled in the art.

Upon completion of reaction, contents of the reactor 14 are pumped to the settling tank 16 for gravitational separation into contaminate leachate 22 and leached solids 24. Upon separation, the settling tank 16 is supplied to collect and convey the contaminate leachate 22 to the leachate processing system 18 and for removing the leached solids 24. The settling tank 16 may be top or bottom unloading, or both. In the embodiment of the present invention utilizing the top unloading configuration, a floating device connects to a pump and a discharge pipe. In the embodiment of the present invention utilizing the bottom unloading configuration, a submersible collection pump is used to discharge effluent. In either embodiment, the metering equipment and collection pumps are connected to discharge pipes connected to the leachate processing system. The pumps provide the reactor with sufficient vacuum suction for collecting the supernatant contaminant containing leachate from within the reactor and delivering it to the leachate processing system. The collected contaminant containing leachate is metered by a flow meter to control mass balance. Preferably, the pumps are liquid ring pumps, which allow the collection system to be a tri-phasal material handling system. This enables the collection system to handle gaseous, liquid and solid phases conveying the contaminate leachate, released contaminants, excess water, and some fines by exerting a negative pressure within the reactor.

The leachate processing system 18 includes a second reactor 42 for receiving the contaminant containing leachate 22. The second reactor 42 demobilizes the dissolved contaminants through chemical processes. The contaminate leachate 22 may also include particulate matter 50, which are extracted and sent to the solids processing system 20. A chemical treatment tank 52 supplies the second reactor 42 through a chemical delivery line 56. The demobilized contaminates are extracted and sent for proper disposal. Recycled lixiviant 28 is returned to the lixiviant delivery system 12. The leachate processing system 18 may be a precipitation system, a filtration system, a concentration system or a partitioning system, which are all known in the art.

The chemical delivery line 56 includes a peristaltic pump for delivering liquids or a metering auger for delivering solids. The chemical delivery line 56 connects to the chemical treatment tank 52 to provide various chemicals for demobilizing and extracting contaminants from the contaminant containing leachate. The recycled lixiviant 28 connects between the second reactor 42 and the lixiviant tank 36 for delivering recycled lixiviant to the lixiviant delivery system 12. An auger/conveyor system may be operably mounted within both the settling tank 16 and the second reactor 42 to withdraw contaminant solids and sludge. In turn, a conveyor is aligned to convey the contaminant sludge away from the settling tank 16 and the second reactor 42 and into a temporary storage container. This sludge may be dewatered by adding, for example, 3% clinoptilolite for stabilization and then removing water from the stabilized sludge by using a filter press. Alternatively, the water from the stabilizer sludge may be removed by solar or thermal evaporators. The resultant contaminant material may then be collected, packed in appropriate containers and shipped to a final disposal site.

Alternatively, the settling tank 16 may include a corrosion resistant container with an inclined bottom, which enhances the ability of the auger/conveyor system to withdraw settled sludge and solids. The capacity of the settling tank should conform to the size of the project. Settling time, and consequently extraction time, are much longer when the leachate includes significant amounts of fine-grained material, as opposed to larger particles, which settle in a shorter period of time. Therefore, the longer the settling time requirement, the larger the settling tank (or tanks). In embodiments of the present invention utilizing this type of settling tank, the second reactor 42 is about two times larger than the settling tank 16 because a longer residence time is required for the chemical reactions to occur within the chemical treatment tank.

In an alternative embodiment, the leachate processing system 18 includes a filter housing having an appropriate filter material or ion exchange media. The contaminant containing leachate is directed to the filter, whereby producing a contaminant-free leachate solution and a contaminant-laden filter media. The contaminant free leachate solution is then recycled and the contaminant laden filter media is packed and disposed of by suitable disposal methods.

In another alternative embodiment, the leachate processing system 18 includes a reverse osmosis membrane system. The contaminant containing leachate 22 is directed to the reverse osmosis membrane system, whereby producing a contaminant-free leachate solution and a concentrated contaminant-laden liquid. The contaminant-free leachate solution is then recycled and the contaminant-laden concentrate is sold to industry for extraction and reuse of target compounds.

The solids processing system 20 includes a screw press and air drier for removing excess leachate and/or water. The removed leachate is sent to the leachate processing system where the contaminants are removed as described. The leached and dried solids can then be sent for proper disposal or for further processing.

In operation, a sample of waste is analyzed to determine the type and concentration levels of the target compounds in order to determine the type of chelating agent to be used, and the amount of the chelate required for an effective extraction process. The relevant waste characteristics can be assessed in order to effectively model the leaching and contaminant extraction process. The solid matter may be tested to identify contaminant type, quantities and characteristics. These waste characteristics and the modeling efforts may be valuable in designing the lixiviant delivery system, application pattern and collection system configuration, as well as for estimating the leaching duration and expected leaching pattern.

Several samples may be collected from contaminated solid matter and other wastes. When treating waste from multiple sources, one or two samples may be collected from each batch to represent variations within the feed material. Upon completion of the sampling process, various laboratory tests may also be performed on the contaminated solid matter with their results incorporated into a design for the contaminant removal system. Some of these laboratory tests include bulk density, contaminant concentration levels and moisture content. Bulk density and moisture content values will determine the amount of air filled pore space in the particulate matter for determining the volume of the chelating agent solution required. The knowledge of concentration levels will enable those skilled in the art to determine the chelating agent concentration levels required.

Once the remediation system 10 is in place, the removal process may be activated. Waste characterization is conducted and the amount of contaminants in the waste determined. As described, the waste may be shredded, ground or chipped to produce appropriate particulate size. The waste is conveyed from a grinder 70 into the leaching reactor 14 using an appropriate conveying mechanism which may be either pneumatic, mechanical or hydraulic. In dispensing the lixiviant, about 1000 liters of fresh water per ton of particulate matter is pumped into the mixing tank 38. Lixiviant having an appropriate concentration, preferably 0.01 to 1.0 moles per liter, is injected when necessary, to achieve a desired concentration which depends upon the particular system in connection with the particular waste for the lixiviant. The lixiviant is agitated using the mechanical agitator before it is pumped into the reactor.

Suitable lixiviants include, but are not limited to, the following chelating agents: nitric, citric, sulfuric or similar acid. Suitable chelating agents may further include salts which are degradable by elements available in the environment such as biota (flora and fauna), bacteria, fungi, light and redox potential. Preferably, these salts are benign to human health and may be regularly used in the medical industry as agents to flush harmful metals from the human body.

Most preferably, the chelating agent is a 0.01-1.0 M/l solution of EDTA, including [diethylenetriamine-N, N, N′, N″, N′-pentaacetic acid], which has the following specifications as listed in Table 1:

TABLE 1
Specifications of Diethylenetriamine-N,N,N′,N″,N′-pentaacetic Acid

| Solubility | 0.46 g/100 mL at 25° C. |
|---|---|
| Assay | >99% (titration |
| Appearance | white crystals |
| Sulfated ash | <0.2% |
| Heavy metal (as Pb) | <0.001% |
| Fe | <0.0005% |

Alternatively, if concentrations of the target contaminate are greater than 3000 mg/L of As, Cr, or Cu, EDTA Free Acid [ethylenediamine-N,N,N′, N′-tetraacetic acid] may be used as the chelating agent to mobilize the contaminants in the contaminated solid matter. The specifications for EDTA Free Acid are listed in Table 2.

TABLE 2
Specifications of Ethylenediamine-N,N,N′,N′-tetraacetic Acid

| Solubility | .34 g/100 mL, at 25° C. |
|---|---|
| Assay | >99% (titration) |
| Appearance | white powder |
| Sulfated ash | <.2% |
| Heavy metal (as Pb) | <0.0005% |
| Fe | <0.0005% |

It should be noted, however, that other salts of EDTA Free Acid may be used to perform the present invention including, but not limited to, the following: 2Na, ethylenediamine-N,N,N′,N′-tetraacetic acid, disodium salt, dihydrate; 3Na, ethylenediamine-N,N,N′,N′-tetraacetic acid, trisodium salt, trihydrate; 4Na, ethylenediamine-N,N,N′,N′-tetraacetic acid, tetrasodium salt, tetrahydrate; 2K, ethylenediamine-N,N,N′,N′-tetraacetic acid, dipotassium salt, dihydrate; 2Li, ethylenediamine-N,N,N′,N′-tetraacetic acid, dilithium salt, monohydrate; and 2NH4, ethylenediamine-N,N,N′,N′-tetraacetic acid, diammonium salt. Each of these EDTA Free Acid salts is suitable for extraction of particular contaminant ion concentrations between 3000 mg/L and 8000 mg/L.

The dispensing system applies the selected lixiviant to the contaminated solid matter. The required capacities of the pumps may be determined from the waste characterization and modeling, which can also determine the rate at which the lixiviant is to be dispensed to the contaminated feed matter. Because the contaminated feed matter may contain widely varying contamination levels, the solution should be dispensed and thoroughly mixed with the feed matter.

Temperature of the mixture is monitored to maintain a desired temperature level depending on the type of waste and amount of removal rate required. This is preferably achieved by supplying dry or moist heat through a bank of heat exchangers which are connected to a heat source. Temperature will enhance the operation of dislodging contaminants from the contaminated waste and keep the contaminants in the leachate solution.

The mixture is allowed to react for a predetermined time period which depends upon the type of waste, type of lixiviant, reaction temperature, and desired level of contaminant removal. Upon completion of the set time, the mixture is transferred to the settling tank and allowed to settle wherein the mixture partitions into solids and liquid phases. The supernatant, which contains the contaminant containing leachate, is then decanted and transferred to the chemical treatment tank. After the supernatant is in the tank, acidity is decreased to an approximate value greater than pH 9 to facilitate precipitation of the dissolved ions as insoluble salts. The supernatant from the chemical treatment tank is monitored for target compounds. If any target compounds remain in the supernatant at this point, it may be passed through a bed of zeolites, or any other cation exchange medium, for example 3% clinoptilolite, to extract the remaining contaminants from the supernatant. If any target contaminants further remain in the supernatant, a 0.1 molar solution of hexane, or other similar organic complexing agent, is added to the supernatant to extract the contaminants and to form a floating phase that will separate from the supernatant. The floating material is then be skimmed from the supernatant and evaporated. The vapors are then be captured and condensed for reuse in the lixiviant delivery system and concentrated contaminants are left for disposal.

Settled sludge from the settling tank and settled salts/solids from the chemical treatment tank are withdrawn from the tanks by the auger/conveyor system and are deposited as sludge into the temporary storage container. This sludge may be tested for target compounds. The sludge, which contains 40% to 60% water, is stabilized by adding a cation exchange medium as described. The sludge is then dewatered by using a filter press to extract the water or solar/thermal evaporators to evaporate the water. The resultant material is then packed in appropriate containers and shipped to the final disposal site. In this manner, contaminants are extracted from the contaminant containing leachate.

Once the contaminants have been extracted from the demobilized supernatant in the chemical processing tank and disposed via the auger/conveyor system, the reclaimed supernatant is recycled as lixiviant.

Alternatively, upon completion of the leaching process, the remediation system is operated without the addition of lixiviant into the mixing tank. In other words, fresh water is introduced into the reactor and is mixed for an appropriate amount of time. Upon completion of this mixing process, the mixed liqueur is pumped to a screw press or a centrifuge separator and dewatered. Separated solids are assayed for any target contaminants to ensure sufficient removal. Based on the level of contaminant in the processed waste, the waste is recycled, landfilled or re-cleaned. Separated liquid is directed to the leachate processing plant for extraction of the contaminants.

### EXAMPLE 1

32 grams of the comminuted treated wood was used to represent 1 mole of the contaminants, and was reacted with 1000 ml of 0.1 mole ethylenediamine-N,N,N′,N′-tetraacetic acid at a temperature of 70° C. for a period of 6 hours. The sample was agitated and allowed to settle periodically to thoroughly mix the wood and the solution, as well as to facilitate leaching. After the last settling period, the mixture stratified into a green colored supernatant which contained the chelated CCA components in soluble form at the top, and clean looking sawdust at the bottom of the reaction container.

Upon completion of reaction, the supernatant was decanted and retained. The solid section was allowed to drain freely for 15 minutes, after which 500 ml of fresh water was added and the mixture was periodically mixed and allowed to settle for a period of 30 minutes. Similarly, the mixture stratified into a light green solution and cleaner looking saw dust. The liquid was decanted and added to the previously decanted liquid. The settled solids were wrapped in a 250μ filter paper and subjected to a weight of 6 pounds per square inch and allowed to drain. Upon completion, the drained liquid was added to the previously decanted liquids and sent for laboratory analysis. The retained solids were oven dried and analyzed for the target contaminants.

Both the contaminant containing leachate and the leached solid matter were analyzed for the target compounds and other contaminants. The results indicated a very significant amount of target contaminants in the contaminant containing leachate and a rather smaller amount of target compounds in the cleaned solid matter. The levels in the cleaned solid matter were up to two orders of magnitude smaller than that of the initial solid matter. Removal rates on a weight basis, before being adjusted for moisture content, varied from 84.47% Cr, 93.28% for As and 95.54% for Cu. The moisture content of the pressed solids was 82%.

### EXAMPLE 2

100 grams of the comminuted treated wood was used to represent 1 mole of the contaminants and reacted with 1000 mL of 0.1 mole EDTA disodium solution at 30° C. for 30 hours. The sample was agitated and settled periodically to thoroughly mix the wood and the solution, as well as to facilitate leaching. After the last settling period, the mixture stratified into a green colored supernatant which contained the chelated CCA components in soluble form at the top, and clean looking sawdust at the bottom of the reaction container.

Upon completion of reaction, the supernatant was decanted and retained. The solid section was allowed to drain freely for 15 minutes, after which 500 ml of fresh water was added and the mixture was periodically mixed and allowed to settle for a period of 30 minutes. Similarly, the mixture stratified into a light green solution and cleaner looking saw dust. The liquid was decanted and added to the previously decanted liquid and was sent for analysis. The settled solids were wrapped in a 250μ filter paper and subjected to a weight of 6 pounds per square inch and allowed to drain. Upon completion, the drained liquid was added to the previously decanted liquids and sent for laboratory analysis. The retained solids were oven dried and analyzed for the target contaminants.

Both the contaminant containing leachate and the leached solid matter were analyzed for the target compounds and other contaminants. The results indicated a very significant amount of target contaminants in the contaminant containing leachate and a rather smaller amount of target compounds in the cleaned solid matter. The levels in the cleaned solid matter were up to two orders of magnitude smaller than that of the initial solid matter. Separated solids were tested for Toxicity Characteristic Leaching Procedure (TCLP) in order to determine the leachabilty of the CCA compounds from the clean wood. It was determined that the TCLP levels in the clean wood were 0.737 mg/L for As, 0.16 mg/L for Cr and 0.06 mg/L for Cu. Removal rates on a weight basis, before being adjusted for moisture content, varied from 90.86% for Cr, 96.36% for As and 98.35% for Cu. The moisture content of the pressed solids was 74%.

### EXAMPLE 3

100 grams of comminuted treated wood was used to represent 1 mole of contaminants, and reacted with 1000 ml of 0.01 mole of EDTA Free Acid solution at 70° C. for 6 hours. The sample was agitated and allowed to settle periodically to thoroughly mix the wood and the solution, as well as to facilitate leaching. After the last settling period, the mixture stratified into a green colored supernatant which contained the chelated CCA components in soluble form at the top, and clean looking sawdust at the bottom of the reaction container.

Upon completion of reaction, the supernatant was decanted and retained The solid section was allowed to drain freely for 15 minutes, after which 500 ml of fresh water with a known quality was added and the mixture was periodically mixed and allowed to settle for a period of 30 minutes. Similarly, the mixture stratified into a light green solution and cleaner looking saw dust. The liquid was decanted and added to the previously decanted liquid and was sent for analysis. The settled solids were wrapped in a 250μ filter paper and subjected to a weight of 6 pounds per square inch and allowed to drain. Upon completion, the drained liquid was added to the previously decanted liquids and sent for laboratory analysis. The retained solids were oven dried and analyzed for the target contaminants.

Both the contaminant containing leachate and the leached solid matter were to be analyzed for the target compounds and other contaminants. The results indicated a very significant amount of target contaminants in the contaminant containing leachate and a rather smaller amount of target compounds in the cleaned solid matter. The levels in the cleaned solid matter were up to two orders of magnitude smaller than that of the initial solid matter. Removal rates on a weight basis, before being adjusted for moisture content, varied from 90.09% for Cr, 96.09% for As and 99.75% for Cu. Moisture content of the pressed solids was 71%.

Results of the three examples are set out in Table 3 below.

TABLE 3

| | | Contaminants | | |
|---|---|---|---|---|
| | | mg/l (liquid) | | |
| | | or mg/kg (solid) | | |
| | Material | Arsenic | Chromium | Copper |
| Initial Sample | WOOD | 3020 | 3380 | 1991 |
| EXAMPLE 1 | | | | |
| Leachate | LIQUID | 22.80 | 4.0 | 79 |
| Processed | WOOD | 203 | 525 | 88.73 |
| Solids | | | | |
| Percent Removal | | 93.28 | 84.47 | 95.54 |
| EXAMPLE 2 | | | | |
| Leachate | LIQUID | 29.80 | 5.67 | 69.60 |
| Processed | WOOD | 110 | 309 | 32.83 |
| Solids | | | | |
| Percent Removal | | 96.36 | 90.86 | 98.35 |
| EXAMPLE 3 | | | | |
| Leachate | LIQUID | 57.60 | 19.60 | 40 |
| Processed | WOOD | 118 | 308 | 4.88 |
| Solids | | | | |
| Percent Removal | | 96.09 | 90.89 | 99.75 |

Although the present invention has been described with reference to preferred embodiments, workers skilled in the art will recognize that changes may be made in form and detail without departing from the spirit and scope of the invention.

1. An environmentally benign method of remediating contaminated particulate matter within a vessel, the method comprising the steps of:
identifying a contaminant contained within the particulate matter;
selecting a chelating agent to chemically react with the contaminant to form a chelate;
contacting the particulate matter with the chelating agent; and
separating the chelate from the particulate matter.

2. The method of claim 1 wherein the chelating agent comprises Ethylenediaminetetraacetic acid.

3. The method of claim 2 wherein the chelating agent comprises diethylenetriamine-N, N, N′, N″, N′-pentaacetic acid.

4. The method of claim 1 wherein the chelating agent comprises Ethylenediaminetetraacetic acid Free Acid.

5. The method of claim 4 wherein the Ethylenediaminetetraacetic acid Free Acid includes ethylenediamine-N,N,N′,N′-tetraacetic acid.

6. The method of claim 1 wherein the chelating agent comprises a salt derivative of Ethylenediaminetetraacetic acid Free Acid.

7. The method of claim 6 wherein the Ethylenediaminetetraacetic acid salt includes:
2Na, ethylenediamine-N,N,N′,N′-tetraacetic acid, disodium salt, dihydrate;
3Na, ethylenediamine-N,N,N′,N′-tetraacetic acid, trisodium salt, trihydrate;
4Na, ethylenediamine-N,N,N′,N′-tetraacetic acid, tetrasodium salt, tetrahydrate;
2K, ethylenediamine-N,N,N′,N′-tetraacetic acid, dipotassium salt, dihydrate;
2Li, ethylenediamine-N,N,N′,N′-tetraacetic acid, dilithium salt, monohydrate; or
2NH4, ethylenediamine-N,N,N′,N′-tetraacetic acid, diammonium salt.

8. The method of claim 1 and further comprising the step of heating the chelating agent and the particulate matter.

9. The method of claim 8 wherein the chelating agent and the particulate matter are heated to at least 30° C.

10. The method of claim 1 and further comprising the steps of:
identifying a second contaminant contained within the particulate matter;
selecting a second chelating agent to chemically react with the second contaminant to form a second chelate;
contacting the second chelating agent with the particulate matter; and
separating the second chelate from the particulate matter.

11. The method of claim 10 wherein the second chelating agent comprises Ethylenediaminetetraacetic acid, Ethylenediaminetetraacetic acid Free Acid, a salt of Ethylenediaminetetraacetic acid or a salt of Ethylenediaminetetraacetic acid Free Acid.

12. The method of claim 1 wherein the contaminant includes copper, chromium, arsenic, mercury, uranium, cesium or plutonium.

13. The method of claim 1 wherein the chelating agent includes ethylenediamine, porphine, vitamin B-12, dimercaprol, Ethylenediaminedi(o-hydroxyphenylacetic) acid, N,N′-ethylenebis-2-(o-hydroxyphenyl) glycine, Diethylenetriaminepentacetic Acid, 1,3-Diamino-2-hydroxypropane-N,N,N′,N′-tetraacetic acid or citric acid.

14. The method of claim 1 wherein the chelating agent comprises an Ethylenediaminetetraacetic acid salt having the formula (C₁₀H₁₂XNₙYₘO₈*4H₂O) wherein X and Y are different metal cations and m and n are between 1 and 9.

15. A method of removing contaminants from solid matter, the method comprising the steps of:
positioning the solid matter within a vessel;
contacting the solid matter with a lixiviant, the lixiviant solution comprising Ethylenediaminetetraacetic acid, a salt of Ethylenediaminetetraacetic acid, Ethylenediaminetetraacetic acid Free Acid or a salt of Ethylenediaminetetraacetic acid Free Acid;
extracting the contaminants from the solid matter into the lixiviant; and
separating the lixiviant from the solid matter.

16. The method of claim 15 wherein extracting the contaminants from the solid matter into the lixiviant comprises heating the lixiviant and the solid matter to facilitate a chemical reaction between the lixiviant and the contaminants.

17. The method of claim 16 wherein the lixiviant and the contaminated solid matter are heated to at least 30° C.

18. The method of claim 16 wherein the lixiviant and the contaminated solid matter are chemically reacted for at least 2 hours.

19. The method of claim 15 and further comprising the step of comminuting the contaminated solid matter into particulate solid matter.

20. The method of claim 15 wherein the salt of Ethylenediaminetetraacetic acid Free Acid comprises:
2Na, ethylenediamine-N,N,N′,N′-tetraacetic acid, disodium salt, dihydrate;
3Na, ethylenediamine-N,N,N′,N′-tetraacetic acid, trisodium salt, trihydrate;
4Na, ethylenediamine-N,N,N′,N′-tetraacetic acid, tetrasodium salt, tetrahydrate;
2K, ethylenediamine-N,N,N′,N′-tetraacetic acid, dipotassium salt, dihydrate;
2Li, ethylenediamine-N,N,N′,N′-tetraacetic acid, dilithium salt, monohydrate; or
2NH₄, ethylenediamine-N,N,N′,N′-tetraacetic acid, diammonium salt.

21. The method of claim 15 wherein the lixiviant comprises diethylenetriamine-N, N, N′, N″, N′-pentaacetic acid.

22. The method of claim 15 wherein the lixiviant comprises ethylenediamine-N,N,N′, N′-tetraacetic acid.

23. The method of claim 15 wherein the lixiviant comprises the salt of Ethylenediaminetetraacetic acid having the formula (C₁₀H₁₂XNₙYₘO₈*4H₂O) wherein X and Y are different metal cations and m and n are between 1 and 9.

24. The method of claim 15 wherein the contaminants include copper, chromium, arsenic, mercury, uranium, cesium or plutonium.

25. The method of claim 15 wherein the contaminated solid matter includes CCA treated wood.

26. The method of claim 15 wherein the lixiviant comprises 0.01-1.0 moles per liter of the Ethylenediaminetetraacetic acid, the Ethylenediaminetetraacetic acid Free Acid, the salt of Ethylenediaminetetraacetic acid or the salt of Ethylenediaminetetraacetic acid Free Acid.

27. A method of extracting copper, chromium or arsenic from treated wood, the method comprising the steps of:
comminuting the treated wood into particulate matter;
contacting the particulate matter with a lixiviant, the lixiviant solution comprising a chelating agent to chemically react with the copper, the chromium or the arsenic to form a chelate, the chelate being soluble within the lixiviant; and
separating the lixiviant from the particulate matter.

28. The method of claim 27 and further comprising the step of heating the lixiviant and the particulate matter to facilitate the chemical reaction between the chelating agent and the copper, the chromium and/or the arsenic to form the chelate.

29. The method of claim 28 wherein the lixiviant and the particulate matter are heated to at least 30° C.

30. The method of claim 27 wherein the chelating agent comprises Ethylenediaminetetraacetic acid,
Ethylenediaminetetraacetic acid Free Acid, a salt of Ethylenediaminetetraacetic acid, or a salt of Ethylenediaminetetraacetic acid Free Acid.

31. The method of claim 30 wherein the chelating agent comprises ethylenediamine-N,N,N′,N′-tetraacetic acid.

32. The method of claim 30 wherein the chelating agent comprises ethylenediamine-N,N,N′,N′-tetraacetic acid.

33. The method of claim 32 wherein the ion concentration of the copper, the chromium or the arsenic is greater than 3,000 mg per liter.

34. The method of claim 30 wherein the chelating agent comprises:
2Na, ethylenediamine-N,N,N′,N′-tetraacetic acid, disodium salt, dihydrate;
3Na, ethylenediamine-N,N,N′,N′-tetraacetic acid, trisodium salt, trihydrate;
4Na, ethylenediamine-N,N,N′,N′-tetraacetic acid, tetrasodium salt, tetrahydrate;
2K, ethylenediamine-N,N,N′,N′-tetraacetic acid, dipotassium salt, dihydrate;
2Li, ethylenediamine-N,N,N′,N′-tetraacetic acid, dilithium salt, monohydrate; or
2NH₄, ethylenediamine-N,N,N′,N′-tetraacetic acid, diammonium salt.

35. The method of claim 34 wherein the ion concentration of the copper, the chromium or the arsenic is greater than 3,000 mg per liter.

36. The method of claim 27 wherein the chelating agent has a concentration of 0.01-1.0 moles per liter of lixiviant.
